(19) United States
(12) Patent Application Publication
(10) Pub. No.: US 2015/0242856 A1
(43) Pub. Date: Aug. 27, 2015

(54) System and Method for Identifying Procurement Fraud/Risk

(71) Applicant: International Business Machines Corporation, Armonk, NY (US)

(72) Inventors: Amit Dhurandhar, Yorktown Heights, NY (US); Markus R. Ettl, Ossining, NY (US); Bruce C. Graves, Briarcliff Manor, NY (US); Rajesh K. Ravi, Yorktown Heights, NY (US)

(73) Assignee: International Business Machines Corporation, Armonk, NY (US)

(21) Appl. No.: 14/186,071

(22) Filed: Feb. 21, 2014

(51) Int. Cl. G06Q 20/40; G06Q 50/00

(52) U.S. Cl. CPC G06Q 20/4016; G06Q 20/405; G06Q 50/01

(57) ABSTRACT

A computer-based system provides identification and determination of possible fraud/risk in procurement. Both transactional data and social media data are analyzed to identify fraud and discover potentially colluding parties. A comprehensive solution incorporates text analytics, business/procurement rules, and social network analysis. Furthermore, both unsupervised and supervised machine learning can provide improved accuracy over time as more data is captured and analyzed and updates repeated. The system can include modular or integrated components, allowing for certain customized or commercially available components to be utilized in accordance with the comprehensive solution.

### FIELD OF THE INVENTION

The invention generally relates to computer-implemented systems and methods for identifying fraud/risk in procurement and, more particularly, to the identification of procurement fraud/risk in which social network/social media data is used together with transactional data for identifying possible fraud/risk and collusion and provide more accurate numerical probabilities of illegal activity in procurement.

### BACKGROUND

In ideal circumstances, business is carried out between vendors and customers in a manner which is fair and consistent with the law. In practice, however, fair business practices can be subject to fraud, or deliberate deception by one or more individuals or parties for personal gain and/or to cause harm to others persons or parties. A result is an illegal and unfair advantage for a party committing fraud. Collusion is secret or illegal cooperation or conspiracy, especially in order to cheat or deceive others. Relative to procurement, collusion involves at least two parties making an arrangement or agreement which provides at least one of the parties an unfair and illegal competitive advantage.

Because of the subversive nature of fraud and collusion, such activities can be well hidden and difficult to identify and trace to the responsible parties. Routing out the cause, including identifying entities indicative of fraud, can be a difficult if not sometimes insurmountable task.

In the modern era of electronic communications and transactions, a phenomenal amount of digital data is involved in nearly every type of business. Modern developments in both software and hardware have allowed for data analysis techniques to be developed and directed to detecting and identifying fraud and its perpetrators in a computer-based fashion. In the art of fraud detection and risk analysis, computer-based systems are developed and relied upon to analyze data and make predictions as to the presence or risk of fraud. Such predictions are often numeric values associated with particular business engagements and transactions between two or more parties.

Despite considerable advances in fraud detection, the ways in which parties can commit fraud have also advanced and become more elusive. There is a persisting need for novel techniques and systems for the detection and identification of fraud and the conspirators responsible.

### SUMMARY

Methods and systems are provided which can provide comprehensive fraud/risk detection and identification.

Generally, an exemplary architecture can be described according to three stages or subsystems: capture, analyze/analysis, and execute/execution. These respectively represent input, processing, and output.

Data which may be captured and utilized according to the invention includes both text-based and numbers-based data. For both of these general data types, data may be also be identified as being privately sourced data (e.g. from one or more private data sources) and/or publicly sourced data (e.g. from one or more public data sources). Privately sourced may include, for example, transactional data, and publicly sourced data may include, for example, social network/social media data. Data is captured from users through electronic input devices or else captured/retrieved from storage media at, for example, one or more data warehouses. Intermediate communication devices, such as servers, may be used to facilitate capture of data.

Analysis involves one or more of text analytics, business logic, probabilistic weighting, social network analysis, unsupervised learning, and supervised learning. These as well as other analysis tools may be configured as individual modules consisting of software, hardware, and possibly firmware, or some or all modules may be integral, sharing particular functions or hardware components.

A text analytics module provides preliminary processing of unstructured, text-based data in order to generate structured data. Encoding of business rules and other statistical criterion into computer-based business logic is a necessary step for analysis of both raw captured data as well as the output of a text analytics module. This analysis is generally performed by an anomalous events module. Initial identification of weights and confidences allows for preliminary results usable to identify possible colluding parties. Numeric results of analysis, including risk indices and probabilities of collusion between one or more parties (e.g. a vendor and buyer employee), are determined in part by the use of weights/probabilities assigned to the various rules and statistical criteria. Social network analysis provides social analytics for data from popular social media platforms. A social network analysis module provides finding and characterizing relationships between colluding parties. The type, nature, and extent of a relationship between a vendor and a buyer employee may bear on the likelihood of collusion and procurement fraud.

Machine learning is used to improve the accuracy of analysis. Both unsupervised and supervised learning algorithms are usable. Supervised learning includes receiving user feedback confirming or identifying true or false positive labels/flags of fraud, risk, or collusion with regard to particular data entities. Both types of machine learning can provide improved weighting of rules and statistical criteria and determination of relationships relevant to fraud and collusion as identified by the social network analysis.

Execution includes a variety of interfaces and display platforms provided through output devices to users. Results generated at execution can also be used to update business rules being applied to future captured data.

### DESCRIPTION OF THE DRAWINGS

FIG. 1 is a procurement fraud taxonomy;

FIG. 2 is a flowchart in accordance with an embodiment of the invention;

FIG. 3 is a components schematic of an embodiment of the invention;

FIG. 4 is an algorithmic flowchart for sequential probabilistic learning;

FIG. 5 is an algorithmic flowchart for determination of confidence of collusion using both transactional and social media data;

FIGS. 6A-6C are sample interfaces for results execution;

FIG. 7 is a network schematic for an embodiment of the invention; and

FIG. 8 is a comprehensive method for generating a total confidence of collusion.

### DETAILED DESCRIPTION

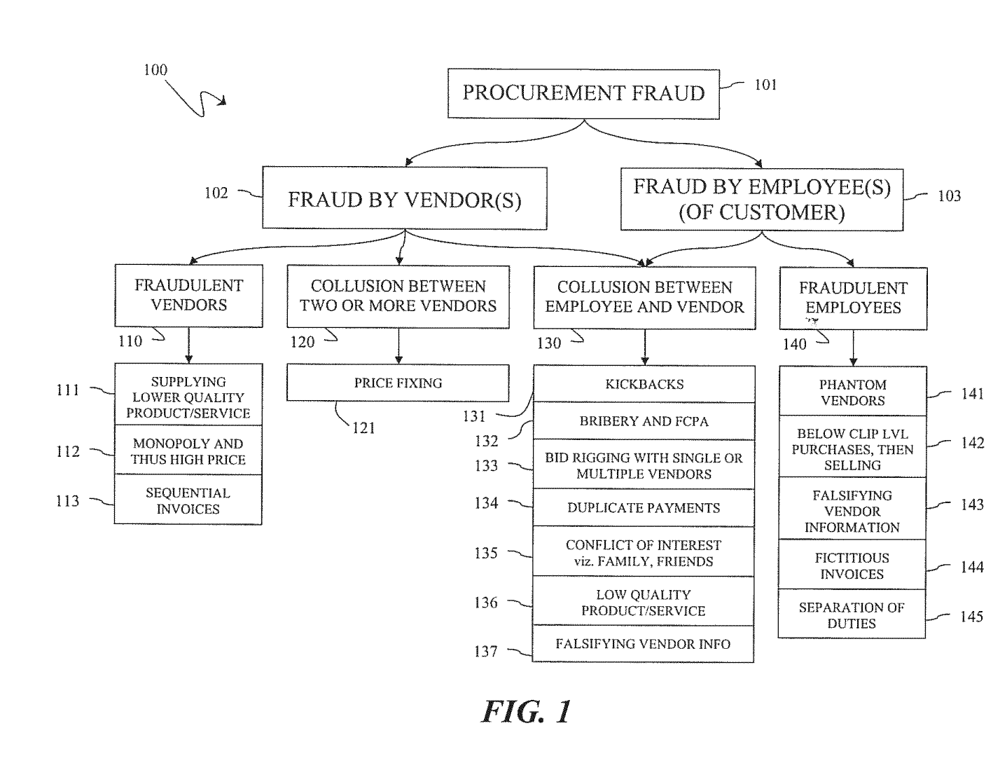

Referring now to the drawings and more particularly FIG. 1, chart 100 presents a non-exhaustive list of types of procurement fraud the present invention is directed to identifying. In general, procurement fraud 101 may be characterized as pertaining to one or more vendors 102, employees 103 of a customer/buyer, or a combination of vendors and employees. Unless indicated otherwise by context, “employees” as used herein will generally refer to employees of a customer/buyer and not of a vendor. “Vendor” may signify a business entity or a person in the employment of that entity.

Fraudulent vendors 110 may deliberately supply a lower quality product or service 111, have a monopoly and thus drive high prices 112, or generate sequential invoices 113. Fraudulent behaviors such as 111, 112, and 113 can be committed by individual vendors without the cooperation or knowledge of other vendors or customer employees. Collusion 120 among vendors may take the form of, for example, price fixing 121. Collusion 130 between vendors and one or more customer employees may involve any one or more of kickbacks 131, bribery and other FCPA violations 132, bid rigging 133, duplicate payments 134, conflicts of interest 135, low quality product/service 136, and falsification of vendor information 137. One or more fraudulent customer employees 140 may independently or in collaboration create phantom vendors 141, make many below clip level purchases followed by sales 142, falsify vendor information 143, generate fictitious invoices 144, and violate rules concerning separation of duties 145. Falsification 132 and 143 of vendor information can include, for example, falsification of master file manipulation, supplier performance records, and report manipulations.

An exemplary embodiment of the invention is directed to identifying any one or more of these various forms of procurement fraud. Preferably all forms of procurement fraud are identifiable. Procurement is generally the acquisition of goods or services from a vendor or supplier by a customer or buyer. It should be appreciated that although the exemplary embodiments discussed herein will be primarily directed to procurement fraud, alternative embodiments of the invention may instead or additionally used in detecting and identifying other forms of fraud, such as sales fraud.

As used herein in the context of the current invention, the expressions “detecting” and “identifying” should be understood to encompass any computer- or machine-based analysis/analytics providing results exposing or making accessible evidence of possible procurement fraud. In general, results will include probabilistic determinations resulting from data processing. Furthermore, “machine learning” should be understood as possibly including what is commonly referred to as “data mining,” which bears notable similarities to unsupervised learning. “Raw data” and “results”, which are both forms of “data”, generally correspond to an input and an output of a process, respectively. However, “raw data” may be an output of a process (for example data capture), and “results” may be an input for a process (for example machine learning).

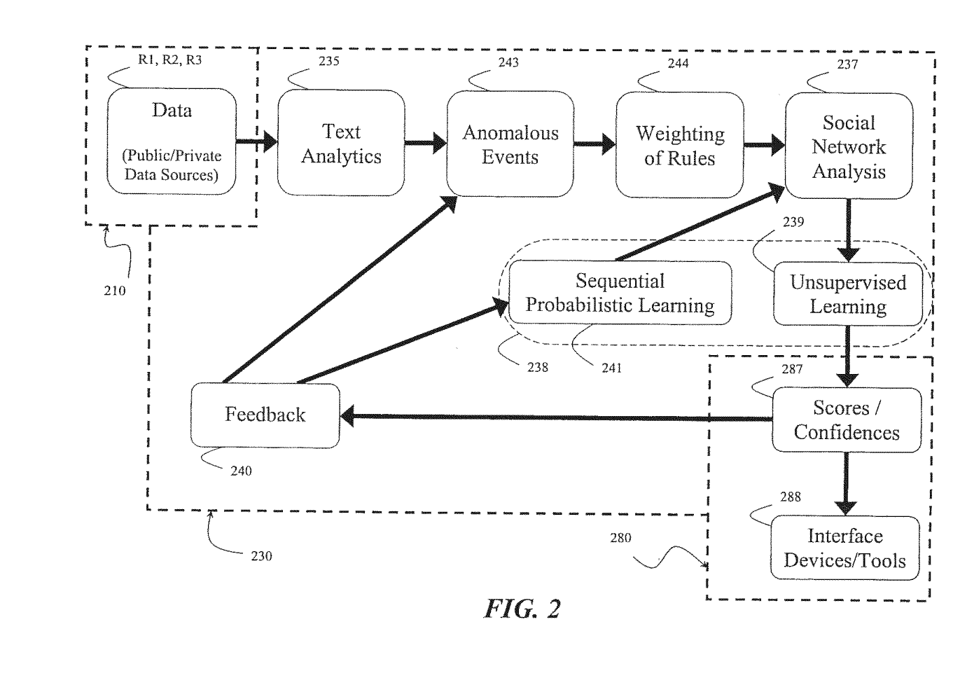

FIG. 2 provides a flowchart of an exemplary embodiment which provides detection and identification of fraud/risk and which is especially well suited for detection and identification of potentially fraudulent/risky entities. “Potentially” as used in this context corresponds to a probability of an entity being fraudulent. Probability is preferably scaled, with a normalized probability distribution having as ends “0”, or absolute certainty of no fraud/risk, and “1”, or absolute certainty of fraud/risk. “Entities” as used herein may include, without limitation, vendors, employees or invoices.

Generally, a method according to the invention includes steps which may be categorized into capturing 210, analysis 230, and execution 280, although it should be appreciated that elements of physical hardware (e.g. processors and servers) configured to perform such steps may in practice be utilized for processes falling into more than one of these stages. Particulars of hardware configuration will be discussed in greater detail below.

Capturing 210 includes intake of data and may include any one or more manual, semi-automated, and fully-automated forms of data collection and initial processing. Manual data collection includes receiving input from human users via input devices (e.g. workstations). Fully-automated data collection includes systematic retrieval of data from data sources. An example of this is a server having a timer mechanism, implemented in software, firmware, hardware, or a combination thereof, which systematically queries data sources and receives requested data in reply. Data sources may include one or more databases or other servers. This is accomplished over an internal and/or external network, which can include encrypted data transfer over the internet. Once servers, databases, networks, etc. are configured for communication with one another, fully automatic data collection can be autonomous and does not necessarily require human intervention, although user input may still be accepted. Semi-automated data collection, as the name implies, falls between manual and full automation. One example implementation is a system largely the same as that just described for fully-automated data collection, except that in place of a timer mechanism, the system may include a user-activated trigger mechanism. The server waits until a certain user input is received via an input device before generating the data retrieval query. In each instance of capturing, captured data is preferably stored on non-volatile memory. A data warehouse may be used for storing both raw data collected during capture as well as processed data.

In contrast to known fraud detection solutions which are designed to monitor and analyze only some forms of privately sourced “transactional” data, an exemplary embodiment of the present invention allows for capture of at least “transactional” data in addition to social network/social media data. Data can be captured from both private and public data sources. Transactional data usable in accordance with the present invention may include purchase order (PO)/invoice data and record field exchange (RFX) data. These and similar data are usually acquired from private data sources such as one or more proprietary data warehouses and servers of a private company or institution. This data is ordinarily only accessible to internal employees or else persons with explicit permissions and access rights granted by an employee (e.g. an administrator) of the enterprise having ownership of the data. In addition, the system may capture existing corruption/fraud indices, policies and business rules, and supplier “red” lists (i.e. forbidden supplier lists) from public data sources such as governmental or watchdog institutions having computer systems and servers which maintain and supply such data upon request. It should be noted that some types of data may be privately sourced as well as publicly sourced. Indices, policies, business rules, and supplier red lists, for example, may come from one or more sources, including those shared among companies in a given industry, those created and supplied by government or independent regulatory agencies, and those maintained internally by a company or institution practicing the invention.

Referring now to FIG. 2, captured data such as R1, R2, and R3 is subjected to analysis/analytics 230. Analytics includes many different aspects which may be implemented in separate or integral hardware. Analysis 230 preferably includes any one or more of the following elements: text analytics module 235, anomalous events module 243, social network analysis 237, and machine learning 238. Machine learning 238 may include both unsupervised learning 239 and supervised learning. Supervised learning is preferably a form of sequential probabilistic learning 241, which will be explained in greater detail below. All of these elements are preferably used in conjunction with one another.

Generally, text analytics involves taking text based data and putting it into a more usable form for further processing or referencing. Text based data can include emails, documents, presentations (e.g. electronic slideshows), graphics, spreadsheets, call center logs, incident descriptions, suspicious transaction reports, open-ended customer survey responses, news feeds, Web forms, and more. A text analytics module 235 according to the invention includes the analysis of keywords/phrases known to be indicative of fraud or potential fraud. This may be accomplished using libraries of words or phrases or text patterns that are not necessarily explicit in showing fraud-related activity or communications but which correspond to fraud, risk, or collusion the invention is configured to detect. In some embodiments, general grammar libraries may be combined with domain specific libraries. For example, for detecting fraud in emails one might have words such as “shakkar”, which has a literal translation of “sugar” but implies bribery in Hindi, as part of a domain specific library. Text analytics may be applied to any text-based data collected in the capture stage 210 to catalog, index, filter, and/or otherwise manipulate the words and content. Unstructured text, which often represents 50% or more of captured data, is preferably converted to structured tables. This facilitates and enables automated downstream processing steps which are used for processing originally unstructured/text-based data in addition to structured/numbers-based data.

In an alternative embodiment, text analytics may be implemented using existing text analytic modules, such as “SPSS Text Analytics” provided by International Business Machines Corporation (IBM). In yet another embodiment, a text analytics module by Ernest & Young LLP (E&Y) may be used in accordance with the invention. A text analytics module is configured to identify communication patterns (e.g. frequency, topics) between various parties, identify and categorize content topics, perform linguistics analysis, parse words and phrases, provide clustering analysis, and calculate frequency of particular terms, among other functions. The IBM SPSS text analytics module provides certain generic libraries, which can be used in conjunction with domain specific libraries and text patterns to create a robust unstructured data mining solution. IBM SPSS allows for the seamless integration of these two sets of libraries along with problem specific text patterns. Suitable text analytics modules which may be used in accordance with the invention will be apparent to one of skill in the art in view of this disclosure.

Preferably after processing of data R1, R2, and R3 via a text analytics module 235, data and/or structured text tables are processed via an anomalous events module 243 configured for detection and identification of anomalous events per business rules and statistical outliers. Business rules which are not yet incorporated into the anomalous events module 243 may be discovered from captured data R1, R2, or R3 via the text analytics module 235 or directly added to the programming by a user. Business logic is instructions which, upon execution by a computer/processor, cause a computer-based system to search, create, read, update, and/or delete (i.e. “SCRUD”) data in connection with compliance or violation of business rules encoded into the instructions. An anomalous events module 243 is configured to implement business logic. As an example, the anomalous events module could automatically check transactional data for the percentage of times an employee awards a contract to one or more specific and limited vendors. Results of this determination can be made immediately available to a user by execution 280 or be transferred to another processing module or stored in a data warehouse for future access/retrieval. An anomalous events module 243 may be configured to automatically check for violations of encoded business rules by either or both vendors and employees.

Anomalous events module 243 preferably incorporates existing business logic implementations such as RCAT by IBM. RCAT is a useful business rules engine but with limited functionality in terms of risk score computation and effective visualization. Moreover, it is biased towards giving many false positives. The anomalous events module 243 of the present invention, however, allows for easy addition of other rules and statistical outlier detection techniques where all anomalous events may be updated over time as further data is made available, captured, and processed. Important to implementation of anomalous events module 243 is identification 244 of initial weights (i.e. importance) of each rule. Initial weights are generally necessary for initial processing and the start to machine learning, which will be discussed shortly. Weights for different rules are updated and adjusted over time to improve the effectiveness of anomalous events module 243. That is to say, updating is a repetitive process that is repeated many times. This provides for the performance to approach that of batch learned weights.

Anomalous events module 243 can allow for initial determinations of possible colluding parties. However, motivations and reasons for collusion are often not readily apparent. This inhibits the accuracy of determining a probability that fraud and/or collusion are in fact present with respect to various entities. Unique to the present invention, publicly sourced data, particularly social network/social media data, is used together with privately sourced data, particularly transactional data, for identifying possible fraud/risk and collusion and provide more accurate numerical probabilities of illegal activity in procurement.

Social network data (i.e. social media data) may be collected or acquired from one or more of a wide variety of social media networks and companies offering social media services. These include but are not limited to Facebook (including lnstagram), Orkut, Twitter, Google (including Google+ and YouTube), LinkedIn, Flixster, Tagged, Friendster, Windows Live, Bebo, hi5, Last.fm, Mixi, Letlog, Xanga, MyLife, Foursquare, Tumblr, Wordpress, Disqus, StockTwits, Estimize, and IntenseDebate, just to name a few. Social media data sources may also include companies and networks not yet in existence but which ultimately bear similarities to, for example, the aforementioned social networks or are otherwise recognizable as social network data sources by those of skill in the art. In addition, the wide variety of blogs and forums available on, for example, the world wide web may also be used as sources of social network data. Social media data may also be sourced from an institution's internal social network(s) available only to employees of that institution, be it a government agency, private enterprise, etc. Third parties who serve as “resellers” of social network data may also be relied upon for capture of social network data. Other social media data sources will occur to those of skill in the art in the practice of the invention as taught herein. Although social media data will generally be categorized as being publicly sourced data, social media data may also be classified as privately sourced data if, for example, the data is retrieved from a server or data archive of a social media service provider/company.

Social media data is processed by a social network analysis module 237 to elucidate or render apparent a tremendous range of relationships or connections, such as but not limited to the following: familial (e.g. both blood and non-blood relatives, including parents, offspring, siblings, cousins, aunts and uncles, grandparents, nieces, nephews, and persons sharing lineage associated with ancestry or posterity), romantic (e.g. boyfriends, girlfriends, significant others, spouses, domestic partners, partners, suitors, objects of affection, etc), greek/fraternal (e.g. brothers of a social fraternity or a service fraternity; sisters of a sorority), professional (e.g. work colleagues, military personnel having worked or served together, volunteers for the same organization or similar organizations supporting a common cause), virtual (e.g. pen pals, members of online interest or support groups), community/regional (e.g. parent-teacher organization (PTO) members, sports team members, neighbors, housemates, roommates), unidirectional (e.g. fans of a popular culture star or politician who don't have a direct relationship but feel and express through social media networks affinity or agreement with such persons or groups), and generalized person-to-person or group-to-group (e.g. between institutions, organizations, or persons having common or shared interests, values, goals, ideals, motivations, nationality, religious ideology, recreational interests, etc). Relationships or connections of interest which may be discerned need not be positive or specific. For example, person-to-person, person-to-group, or group-to-group interaction which includes bigotry, religious intolerance, political disagreement, etc. may also be characterized as relationships or connections of interest.

Any salient relationship, connection, or tie, be it positive or negative, between one person/group and another person/group may be discerned from social media data.

In an exemplary embodiment, a social network analysis module 237 may process social media data in conjunction with transactional data processed via text analytics module 235 and anomalous events module 243. To make a determination if colluding parties are related (e.g. according to one or more of the above identified relationships), a similarity graph may be constructed based on information specific to each individual. Two or more similarity graphs corresponding to separate persons or groups may then be compared and a determination made as to the shortest path between a suspected employee and vendor. Potentially colluding employee(s) and vendor(s) are identified by the anomalous events module 243 as discussed above. Similarity graphs may be compared randomly according to continuous and iterative search and identification processing. More preferably, particular persons or groups are selected for comparison based on initial findings and fraud/risk indicators ascertained through text analytics module 235 and anomalous events module 243. Fraud/risk indicators include higher than normal probabilities of fraud/risk as determined by anomalous events module 243 and specific “anomalous events” (i.e. “intelligent events”).

As presented above, one example of an “anomalous event” may be the finding of an employee's awarding of a particular contract to an unusually small and specific number of vendors in a manner which violates an established business rule of the employee's company. Generally, anomalous events are one or more statistical outliers and/or business rule violations pertaining to an entity as determined from privately sourced data, in particular transactional data. Anomalous events module 243 may be configured to have certain parameters or thresholds which, when met or surpassed by data (e.g. concerning a transaction), cause the module to flag the data as being a statistical outlier or violating a business rule.

A confidence in assessing an “anomalous event” can be improved by identification of comparatively short paths as determined by the social network analysis module 237 using publicly sourced data. When paths from a similarity graph are compared, shorter paths are indicative of a higher probability or confidence of collusion. Building off the anomalous event example just provided, a confidence of collusion when assessing an employee's violation of the business rule may increase if it is determined by a social network analysis module 237 that the employee and a specific vendor to which he routinely awards contracts are relatives.

In an alternative embodiment, a text analytics module 235, an anomalous events module 243, and a social network analysis module 237 may be combined into a primary analytics module. A primary analytics module may include other data analysis functions in addition to those described for modules 235, 243, and 237. A primary analytics module may be developed using existing programming language tools such as Java in conjunction with the IBM product “SPSS (Predictive analytics software and solutions) Modeler”. In an embodiment, text analytics and anomalous events detection may be primarily performed by the SPSS Modeler, allowing for a primary analytics module for data processing and analytics in accordance with the invention without the need for explicit know-how in a programming language. Social network analysis is preferably implemented via a custom programming implementation (e.g. in Java), which will be discussed in greater detail below.

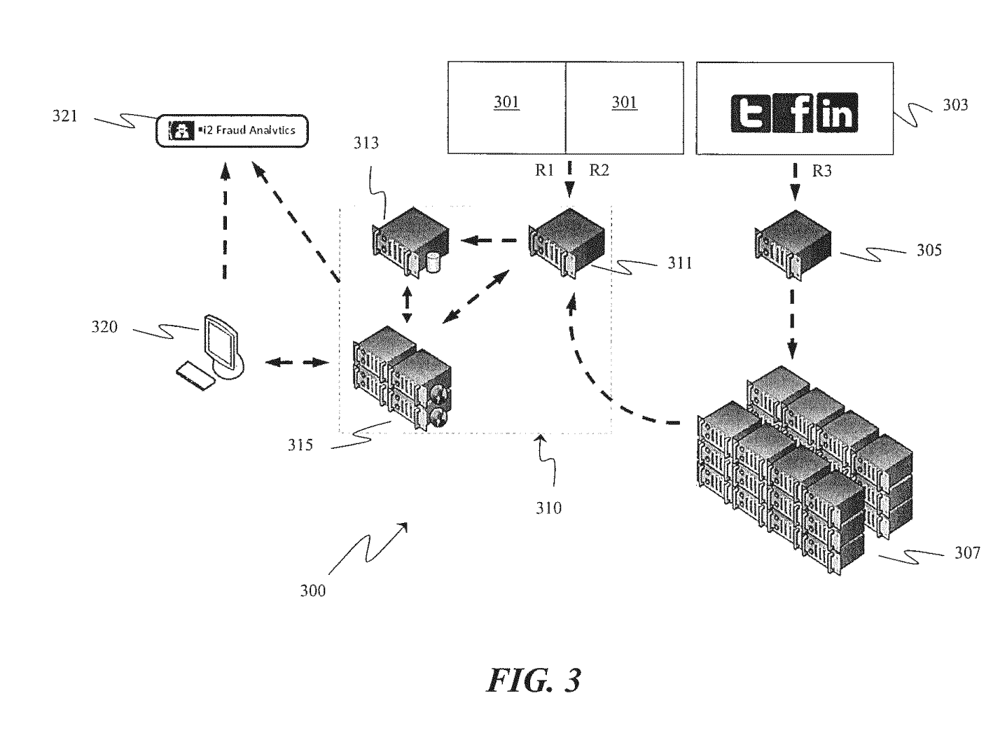

FIG. 3 shows a schematic of a network 300 for implementing the analytics flow shown in FIG. 2. Network 300 generally has at least two types of data sources: private data sources 301 and public data sources 303. As used here, private data sources provide privately sourced data R1 and R2, including transactional data collected and maintained privately by one or more companies. As examples, privately sourced data R1 may be invoice/purchase order (PO) data, privately maintained corruption indices, denied parties/supplier red lists, and company policies. Privately sourced data R2, such as RFX data, may be captured from one or more additional private data sources. Note that the use of two labels—‘R1’ and ‘R2’—for privately sourced data in this instance serves to emphasize that multiple private data sources may be used in combination for data collection/capture. For a company such as International Business Machines (IBM), one possible private data source 301 is the IBM Banking Data Warehouse (BDW). Another is Emptoris eSourcing.

Publicly sourced data R3 is generally captured from public data sources 303. Social media data, though optionally received from social media companies like Twitter, Facebook, or LinkedIn, will be categorized for the purposes herein as publicly sourced data R3 to emphasize the data as originating from the general public making use of social media services. Data analysis 230 and the comprised modules (e.g. modules 235, 243, 237, etc) are preferably contained in a system 310 maintained by the institution practicing the invention. As part of capture 210, publicly sourced data R3 is preferably resolved by a streams processing module 305 and may optionally undergo storage/processing by a hardware cluster 307 such as, for example, a Hadoop cluster, the IBM InfoSphere BigInsights Social Data Analytics (SDA), or similar. Streams processing is generally an online process and may be sufficient for resolving captured data prior to analysis 230. In contrast, a Hadoop cluster 307 can store, sort, and perform other operations offline.

As provided in FIG. 3, system 310 has capturing, processing, and data exchange/serving capabilities. A server 311 may be used for initial capture and relay of captured data R1, R2, and R3. One or more computer/server units 313 and 315 provide data analysis 230 (e.g. text/entity analytics, SPSS, machine learning 238, etc.) and data exchange between computers, servers, and user interface devices 320. Examples of systems known in the art with which the current invention may be integrated include: Extraction Transformation and Loading (ETL), IBM InfoSphere, and Information Server for server 311; DB/2 Enterprise Server and Relational Database for unit 313; and Analytics Server, WebSphere AppServer, HTTP Server, and Tivoli Director Server for unit 315.

User interface devices 320 may be used for displaying results (e.g. fraud indices/scores) as well as receiving feedback and input customizing settings and parameters for any of the modules of analysis 230. Results may be used as input to existing data interface/investigative tools 321, such as “i2 Fraud Analytics”.

Machine learning is often regarded as a present day form of artificial intelligence due to the fact that a machine “learns” and improves with use. Machine learning entails processes by which a system can become more efficient and/or more accurate with respect to its intended functions as it gains “experience”. In the present invention, machine learning 238 may be implemented in the form of “unsupervised” learning 239 as well as “supervised” learning, or more specifically sequential probabilities learning 241. It should be noted that although unsupervised learning and sequential probabilities learning are shown in independent boxes in FIG. 2, algorithms providing either unsupervised learning or supervised learning may be used integrally with the modules discussed, including analytics module 235, anomalous events module 243, and social network analysis module 237. Unsupervised learning 239 is related to and may include pattern recognition and data clustering, these concepts being readily understood to one of ordinary skill in the art. Algorithms providing for unsupervised learning, and by connection the hardware configured for execution of such algorithms, are provided data generally without labels. In particular, a datum may not be initially distinguished from another datum with respect to supplying a determination of fraud/risk associated with some entity. The algorithms provide for identification of for example, patterns, similarities, and dissimilarities between and among individual datum and multiple data. Unsupervised learning algorithms can effectively take unlabeled data input and identify new suspect patterns as well as sequences of events that occur infrequently but with high confidence.

The sequential probabilistic learning component 241, in contrast to unsupervised learning 239, has labeled data input such that the algorithms effectively have “model” data off of which to draw comparisons and make conclusions. Expert feedback is received from users through input devices such as workstation terminals connected to the system network. Feedback 240 can provide concrete indications of particular data, anomalous/intelligent events, etc. which provide support or evidence of fraud and/or collusion between and among different entities. This feedback, which preferably includes identification of true/false positives in the results generated via the unsupervised learning algorithms 239, may then be used to update parameters affecting future data captured and supplied as input to the social network analysis module 237 and unsupervised learning algorithms 239. Specifically, either or both anomalous events module 243 and weights applied to rules in weighting step 244 may be updated in response to feedback 240. Violation of a business rule does not provide conclusive evidence of fraud or collusion. However, violation of some business rules provides greater confidence of collusion than violation of certain other rules. Thus the former rules should have greater weights. In addition, the frequency, number, and combination of business rules which are violated can be used to improve the accuracy and confidence of collusion respecting fraud/risk between any two or more employees and vendors. Combining this information with social network analysis via a social network analysis module 237 further improves fraud identification results. Results from sequential probabilistic learning 241 fed back to social network analysis module 237 provides a corrective feedback loop which can improve the output (e.g. scores and confidences 287) of unsupervised learning 239.

There are existing algorithms and program modules commercially available which may be used for supervised learning in the practice of the invention. These include, for example, “Fractals” offered by Alaric Systems Limited. Alaric identifies “Fractals” as being “self learning”, whereby the program “adapts” as human users (fraud analysts) label transactions as fraudulent. This solution uses a Bayesian network trained over labeled data to come up with suggestions. The primary limitation of this tool is that it requires labeled data, which in many real scenarios, such as detection of fraud in procurement, is not readily available. A system as taught herein does not require labeled data which makes it more generally applicable. Moreover, the sequential probabilistic learning 241 component is light weight. That is, it is extremely efficient to train with feedback 240 and does not overfit to the data, which results in low false positive rate.

Sequential probabilistic learning 241 of the present invention is preferably online learning. As will be understood by those skilled in the art, machine learning can be generally categorized into batch learning and online learning. Batch learning is a form of algorithm “training,” akin to medical students being trained with human models and simulations prior to working with actual patients. Batch learning is intended to serve as an exploration phase of machine learning in which the results, which may be relatively inaccurate, are not of significant consequence. In contrast, online learning is machine learning “on the job”. Continuing the medicine analogy, online learning by a machine bears similarity to medical students or doctors actually working with patients. The students or doctors may not be perfect, but they are proficient and continue to improve as they work in a consequential context (i.e. with real patients). Similarly, algorithms with online learning may be used to provide fraud/risk and collusion probabilities, with results improving over time.

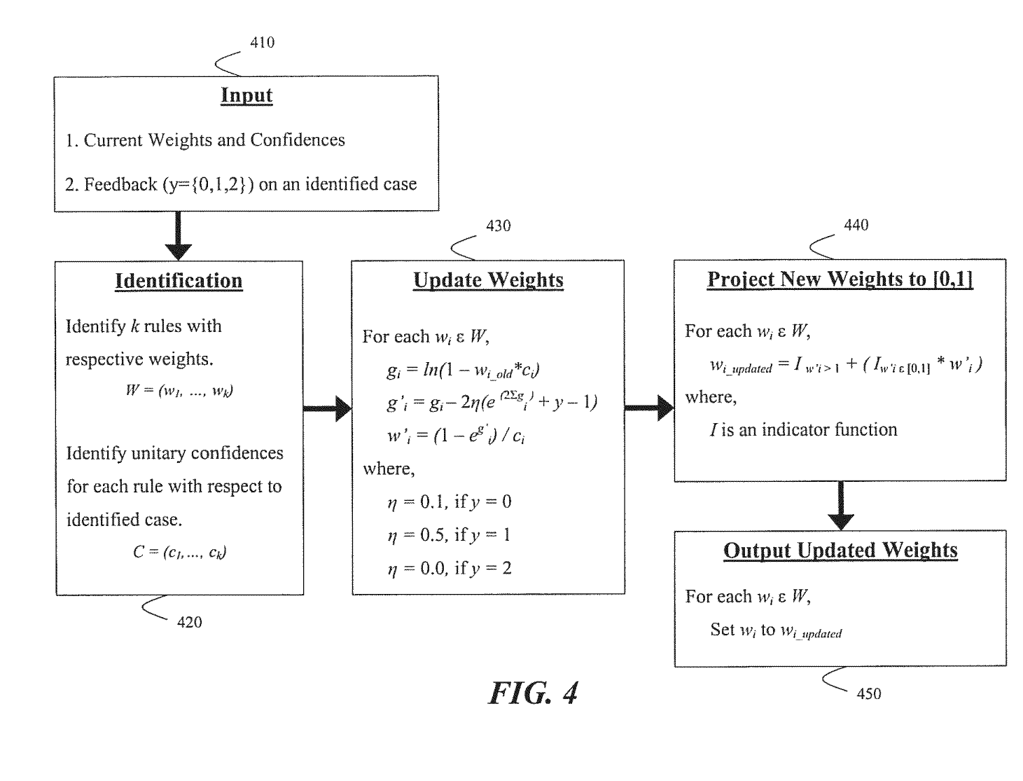

FIG. 4 provides a flow chart which summarizes an exemplary method of sequential probabilistic learning 241 according to the invention. Each business rule or statistical criterion has associated therewith a weight such that a weight is applied to different anomalous events (e.g. violation of a business rule or a statistical outlier in the statistical criteria). Weights determine the relative importance of one anomalous event or business rule as compared to another anomalous event or business rule. Furthermore, weights can be interpreted as the probability of fraud/risk contingent upon the rule or statistical criterion. It should be noted that although the term “rule(s)” may be used alone herein for simplicity, the teachings apply equally to “rule(s)” and “criterion/criteria”. An important feature of the claimed invention is that weights are normalized, or scaled to values in the range [0,1]. This provides substantial semantic advantage. Input 410 preferably includes each current weight (wᵢ) associated with a rule. As indicated at identification step 420, if there are k rules, W may be used to represent the set of weights for all k rules such that:

W=(w₁, . . . , wₖ)

A “case” is an investigation of the business conducted between at least one vendor and at least one employee of the customer. Generally, each case can be evaluated against k business rules/statistical criteria. It should be noted that although an anomalous events module may be configured to utilize as many as M rules/criteria, a case involves a subset of k rules/criteria, where k≦M. A unitary confidence (cᵢ) between the vendor and the employee identified in the case is an unweighted probability of fraud given only one rule/criterion. Thus, for a given case, if there are k rules, C may be used to represent the set of unitary confidences for all k rules, such that:

C=(c₁, . . . , cₖ)

Feedback y received from an expert user may be given as one of three values—0, 1, and 2—such that:

y={0,1,2}

Feedback of “0” implies that a case is identified/labeled as being not fraudulent, Feedback of “1” implies that the case is in fact fraudulent. Feedback of “2” implies that the case is not identified as fraudulent but still interesting and pertinent in updating the weights. To update each rule's weight wᵢ, the set of mathematical instructions summarized in update step 430 of FIG. 4 may be executed:
For each wᵢεW,

gᵢ=ln(1−wᵢ_{_{—}}_{old}*cᵢ)

g′ᵢ=gᵢ−2η(e^{(2Σg}^{ᵢ}⁾+y−1)

w′ᵢ=(I−e^{g′}^{ᵢ})/cᵢ
where,

η=0.1, if y=0

η=0.5, if y=1

η=0.0, if y=2
and
   wᵢ_{_{—}}_{old} is the starting value of the weight wᵢ, and w′ᵢ is the new weight (though not yet projected to [0,1]).

To complete updating a weight wᵢ to a value wᵢ_{_{—}}_{updated}, the value must be normalized to [0,1] according to the following instructions (as provided in project step 440 of FIG. 4):
For each wᵢεW,

Wᵢ_{_{—}}_{updated}=I_{w′i>1}+(I_{w′iε[0,1]}*w′ᵢ)
where,
   I is an indicator function, which is 0 when the condition isn't true and 1 otherwise.

The resulting wᵢ_{_{—}}_{updated} is then stored in a non volatile memory storage medium in addition to or in place of the original value (wᵢ_{_{—}}_{old}) at output step 450 of FIG. 4.

It was indicated above that for k rules, C may be used to represent the set of unitary confidences for a given case as evaluated according to each of k rules, such that:

C=(c₁, . . . , cₖ)

It should be noted that unitary confidences are generally based on privately sourced data, particularly transactional data. A transactional-related confidence of collusion (cᵣ) for a particular case (i.e. a particular vendor and employee) may be determined which takes into account one or more unitary confidences pertaining to the particular case.

It is advantageous to update weights in the manner described above and illustrated in FIG. 4 such that weights are always normalized to the range [0,1]. This contrasts with other update methods including additive updates and multiplicative updates. In the case of additive updates, updated weights are unbounded in both directions with a resulting range of (−∞, ∞). In the case of multiplicative updates, updated weights are unbounded in the positive direction with a resulting range of (0, ∞). Given the normalized range of [0,1] in the present invention, assigning initial weights at weighting 244 in FIG. 2 is easier and therefore more accurate for new rules and statistical criteria, since all weights of existing rules are limited to the bounded range of [0,1]. This provides clearer comparison. Although other normalization methods exist, they generally do not approach batch learned weights and therefore have poorer performance. In contrast, the normalization method of the current invention advantageously approaches batch learned weights.

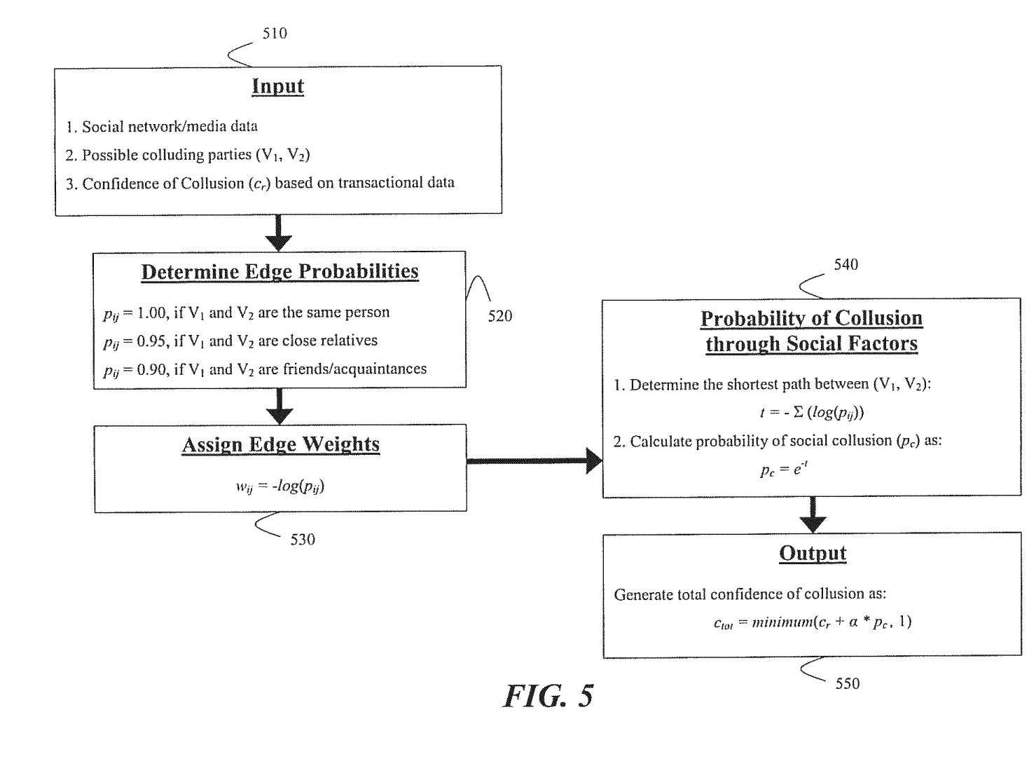

FIG. 5 shows a flow diagram for determining a total confidence of collusion between two parties V₁ and V₂ implicated as being of interest, such as by anomalous events module 243. To generate a total confidence of collusion, given as a decimal fraction in the range [0,1], the instructions summarized in FIG. 5 may be executed by a computer and a final confidence of collusion (cₜₒₜ) stored in non-volatile storage media. A final or total confidence of collusion (cₜₒₜ) reflects information from both transactional data and social media data or, more generally, information from both privately sourced data and publicly sourced data.

As shown at input step 510, input includes social network data, information concerning the possibly colluding parties (V₁, V₂), and a transactional-related confidence of collusion (cᵣ) which is based solely on transactional data. For simplicity, cᵣ may simply be called “a first probability of collusion”. In other words, a confidence of collusion determined just from privately sourced data (e.g. transactional data) may be called a “first probability of collusion”.

If it were detected in transactional data that a single employee approves a majority of the invoices of a particular vendor, then cᵣ would be high. Another example resulting in a high cᵣ is a case where an employee sends out a bid only to a single vendor rather than a group of them to get the best possible price. To obtain the total confidence cₜₒₜ, the invention adds to cᵣ the strength of relationship between V₁ and V₂ based on social network data or other publicly sourced data. The shortest path between these two entities is found using the social network data and the weight wᵢⱼ which accounts for the confidence of collusion (p_{c}) based on social connectedness. For simplicity, p_{c} may simply be called “a second probability of collusion”. In other words, a confidence/probability of collusion determined just from publicly sourced data (e.g. social media data) may be called a “second probability of collusion”. The first probability of collusion (cᵣ) and the second probability of collusion (p_{c}) are combined as shown in FIG. 5.

From the social network data, parties V₁ and V₂ may be placed in whichever one of a plurality of categories describes their relationship most accurately, for example:
{same person; close relatives; friends/acquaintances}

As examples, V₁ and V₂ may be the same person if V₁ and V₂ are two different social profiles, such as a Facebook account and a twitter account, associated with the same individual. Close relatives may be nuclear family members (e.g. parents, siblings, step-parents, step-siblings, offspring). Where there is an extended family familial tie between V₁ and V₂ (e.g. aunts/uncles, great grandparents, cousins, brothers/sisters-in-law, etc), this may be categorized as either “close relatives” or “friends/acquaintances” depending on the extent of salient communication and social interaction as perceived from the social media data processed by the social media analysis module.

Edge probabilities are numerical values in the range [0,1] and correspond with the number of degrees V₁ is removed from V₂. For an embodiment using the three categories identified above, to determine an edge probability (pᵢⱼ), the following rules may apply:
pᵢⱼ=1.00, if V₁ and V₂ are the same person
pᵢⱼ=0.95, if V₁ and V₂ are close relatives
pᵢⱼ=0.90, if V₁ and V₂ are friends/acquaintances

More than three relationship categories/types may be used in the practice of the invention. In all cases, close, more connected relationship categories will have larger edge probability values than distant, less connected relationship categories.

An edge weight (wᵢⱼ) can be determined using the following formula:

wᵢⱼ=−log(pᵢⱼ)

To determine a probability of social collusion (p_{c}) based entirely on social media data and not on transactional data, the following two steps may be performed (see probability determining step 540 in FIG. 5):

First, determine the shortest path between (V₁, V₂)

t=−Σ(log(pᵢⱼ))

The probability of social collusion (p_{c}) is then given by:

p_{c}=e^{-t}

The final output, which is a total confidence of collusion (cₜₒₜ) taking into account both the confidence of collusion (cᵣ) based on transactional data alone and the probability of collusion (p_{c}) based on social media data alone can be determined by the following algorithm as provided at output step 550 of FIG. 5:

cₜₒₜ=minimum(cᵣ+α*p_{c},1)

In words, a total or final confidence of collusion based on both privately sourced data (e.g. transactional data) and publicly sourced data (e.g. social media data) is the combination of both first and second probabilities of collusion, where this combination is a weighted sum of the first and second probabilities of collusion constrained to a range of [0,1]. This sum is preferably the confidence of collusion (cᵣ) based only on transactional data plus the probability of collusion (p_{c}) based only on social media data adjusted by a constant co-factor (α), where co-factor α lies in [0,1] and acts as a discount factor to be determined by a user based on his/her trust in the quality of the social network data. If this sum exceeds 1, then cₜₒₜ is 1. A total confidence of collusion (cₜₒₜ) will always be in the range of [0,1].

It is worth noting that the concept of shortest path determination is well known in the art and pertains to mathematics, in particular discrete mathematics and graph theory. How shortest paths are used and applied in the art vary, and novel implementations, such as that which is taught herein, continue to be developed.

Generally, a risk index, or score, for a vendor or employee is a number describing an overall probability of fraud taking into account many weights and confidences for either or both rules associated with collusion and rules not associated with collusion (but still associated with fraud). In other words, a risk index is computed over multiple independent events which can include collusion but are not limited to it. A risk index can be calculated according to one or more rules. The most general risk index takes into account all rules. However, individual risk indices may be generated which only take into account rules which pertain to a particular topic or category, for example, a vendor's profile, a vendor's country, or a vendor's invoices. For n rules being used to determine a risk index, the risk index may be calculated as:

risk index=1−((1−w₁c₁)* . . . *(1−wₙcₙ))
where wᵢ is the weight and cᵢ is the confidence for the i^{th} rule of the n rules.

So, if three rules (n=3) are used in determining a given risk index, then the following would apply:

risk index=1−((1−w₁c₁)*(1−w₂c₂)*(1−w₃c₃))

Table 1 below provides examples of some individual rules/criteria together with a possible violation and individual weights:

TABLE 1

| Rule | Violation | Weight |
|---|---|---|
| vendor registration | vendor not registered | 0.20 |
| invoice line item amounts | even or round dollar | 0.80 |
| | line item amounts | |
| vendor initials | initials of vendor name nonsensical | 0.80 |
| corruption perception index | perception index above a threshold | 0.50 |
| vendor confidence | low vendor confidence | 0.50 |
| invoice numbers | consecutive invoice numbers | 0.50 |
| invoice amount variability | invoice amount jumps | 0.50 |
| | by 50% or more | |
| invoice totals | round dollar invoice totals | 0.50 |
| use of POs for invoices | mix of invoices with | 0.50 |
| | vs without POs | |

The occurrence of a violation can be identified as an independent anomalous event. As an example, a vendor is identified as not being registered. The rule is clearly violated, so the probability associated with the event is 1.0. A weight of 0.2 would therefore be multiplied by a probability of 1.0 when calculating the risk index. Had the vendor been registered, the probability would be 0.

Although weights for individual rules/criteria may be the same for calculating risks associated with different vendors, the updating process using feedback customizes weights according to the specific vendors. As a result, a weight for a given rule often has a different value with respect to one vendor as compared to another vendor.

Referring again to FIG. 2, execution 280 of results 287 (e.g. risk indices/scores and/or confidences of collusion) includes supplying or providing access to users through one or more interfaces on one or more user interface/output devices 288. According to an exemplary embodiment of the invention, a dashboard interface may provide an interactive interface from which a user can view summary charts and statistics, such as gross fraud or risk averages of captured and processed data, as well as conduct searches by entity, party, transaction type, or some other criterion or criteria. An alerts interface, which may be integral with or accessible from the dashboard, is configured to supply results of particular significance. Such results preferably include entities and parties identified as having high confidences of collusion. A threshold value for characterization as “high” confidence of fraud and/or collusion may be set by a user. This threshold is preferably at least equal to or greater than 0.50. Tabulated lists of vendors and/or employees can be generated and ranked according to each employee or vendor fraud/risk scores and confidences of collusion, as indicated at 287 in FIG. 2. If desired, lists may be sorted and viewed through an “i2 Fraud Analytics” interface 321, as indicated in FIG. 3. List items of high significance may be flagged and reproduced on the Alerts interface.

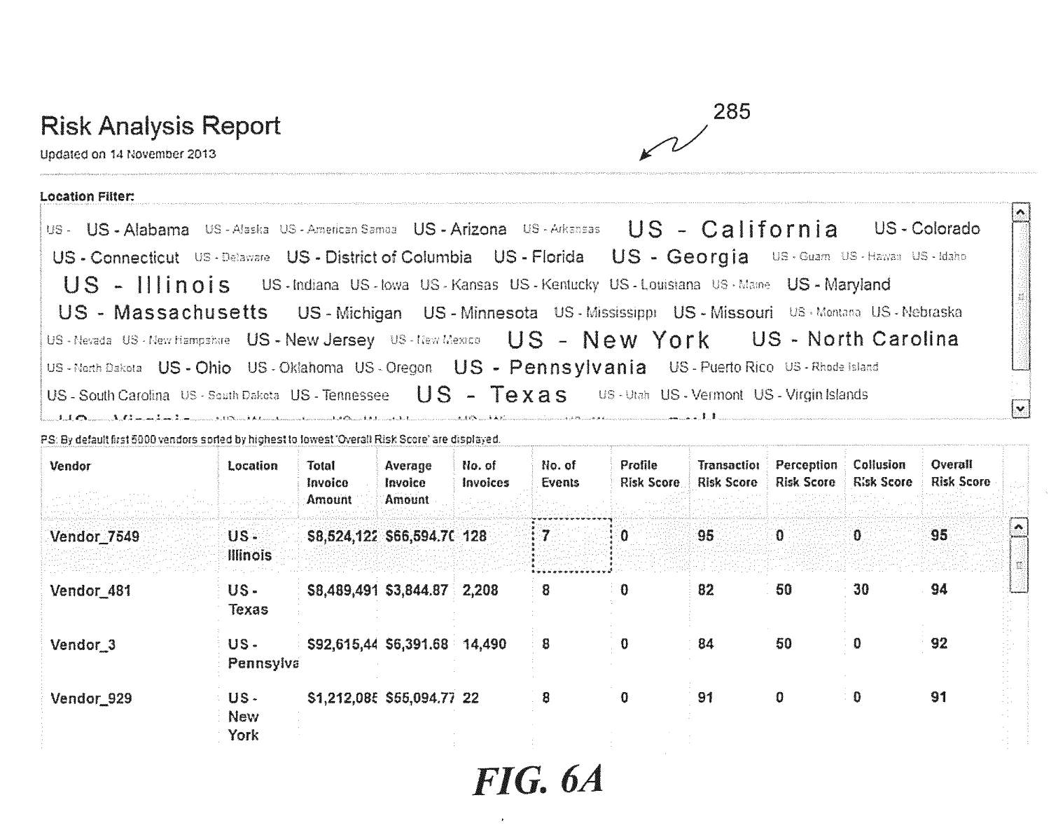

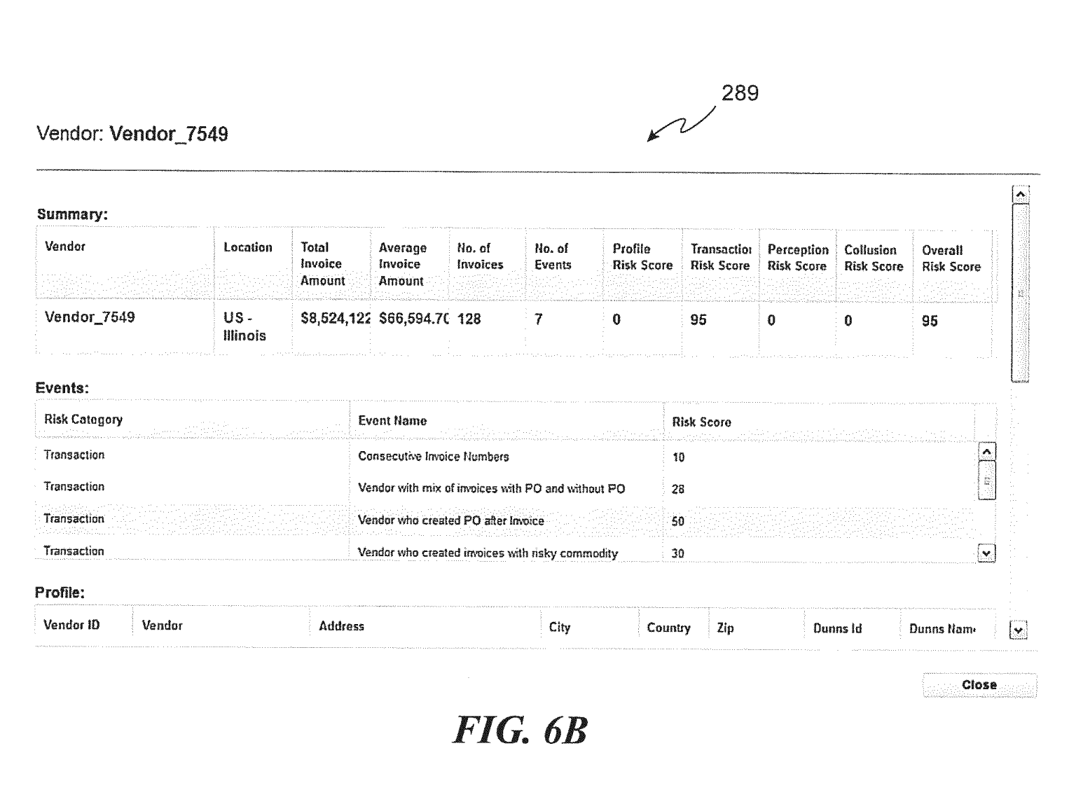

FIGS. 6A-6C show exemplary interfaces for execution 280 of results. FIG. 6A shows one exemplary dashboard display 281. The dashboard shown includes three presentation options: (i) vendor risk index, (ii) vendor average invoice amount vs risk index, and (iii) vendor risk index by US counties. Other presentation options may also be used. ‘Vendor risk index by US counties’ is the specific presentation option shown in FIG. 6A. The continental United States is presented divided into counties. A colored heating gradient, numerically explained in a key 282 to the bottom left of the screen, provides a scale by which individual counties can be viewed and compared against other counties according to a vendor's average risk index according to the county in which a transaction is legally documented as taking place.

FIG. 6B shows an exemplary Fraud Analytics interface 285 titled as a “Vendor Risk Report”. A user is provided the ability to filter procurement transactions according to individual states within the United States. As shown, Maine has been selected. A user (in this case a buyer employee) is presented with a tabulated listing of vendors, together with values for average invoice amount, profile risk score, invoice risk score, perception risk score, and a total risk score. This is one example, and other values and results of the analysis/analytics 230 may be used together or as alternatives to those shown in FIG. 6B.

FIG. 6C shows a vendor profile display 289. Basic information such as vendor address is provided. In addition, individual events as well as invoices are presented in lists, together with risk indices found for each event entity (e.g. invoice, perception, profile, etc). As already discussed, a risk index/score can be generated for individual rules or groups of rules. Note that while the risk index formula provided above provides risk indices in the range [0,1], these scores may optionally be made non-decimal by multiplication by 100, as has been done in FIGS. 6B and 6C.

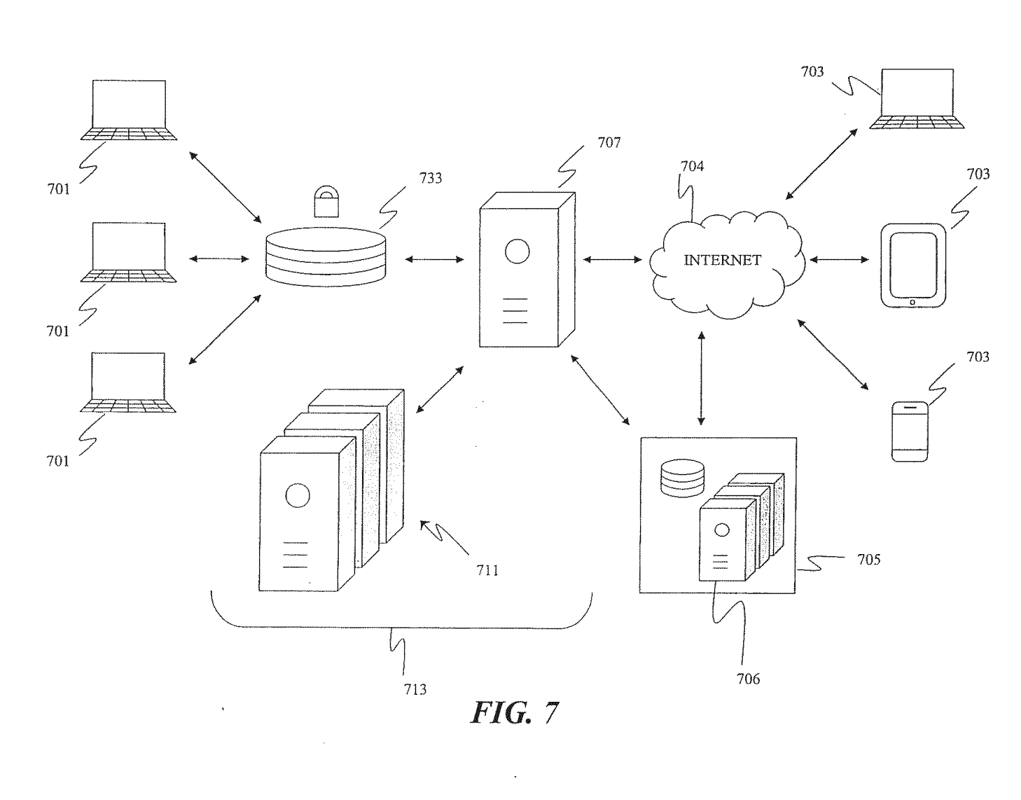

FIG. 7 shows an exemplary network for implementing the capture, analyzing, and execution as shown in FIGS. 2 and 3 and described above. Input and output devices 701 can include workstations, desktop computers, laptop computers, PDAs, mobile devices, terminals, or other electronic devices which can communicate over a network. An input device and output device may be independent of one another or one and the same. Personal electronic devices 703 (i.e. end user devices) are a form of input devices. Any electronics-based data source, including storage media in a data warehouse, may be regarded as an input device for another device in communication with a data source and receiving data therefrom.

Employees and vendors engage in electronic social media platforms via personal electronics devices 703 such as personal computers, tablets, smartphones, and mobile phones. It is also possible employees and vendors use input/output devices at their workplaces for social networking purposes, and thus identification of devices 703 as “personal” is not limited to personal ownership. Most social media platforms which provide “social networks” rely upon the internet 704 for communication with personal electronic devices providing interfaces for persons to upload social data (e.g. by posting, sharing, blogging, messaging, tweeting, commenting, “like”ing, etc.). Generally, social media data is stored at social media network provider facilities 705. One or more servers 707 may capture data over the internet or by direct communication and exchange with one or more servers 706 of the social media network provider facilities 705. In effect, a server 707 can capture data from input devices which include personal electronic devices 703 and other servers 706.

A server 707 stores captured data in one or more data warehouses 733. Generally, data warehouses are repositories of data providing organized storage on non-volatile storage media. Non volatile storage media or storage devices can include but are not limited to read-only memory, flash memory, ferroelectric RAM (F-RAM), types of magnetic computer storage devices (e.g. hard disks, floppy disks, and magnetic tape), and optical discs.

The instructions, algorithms, and software components (e.g. of modules 235, 243, and 237) as taught herein are preferably maintained in either or both a data warehouse 733 and computers 711. One or more computers 711 include one or more central processing units (CPUs)/processors, volatile memory, non-volatile memory, input-output terminals, and other well known computer hardware. Specialized firmware may also be used. When the algorithms, instructions, and modules as taught herein are executed by the CPUs/processors of computers 711, they provide for the processing and alteration of the data stored both locally in the storage media of computers 711 and of the data warehouse 733. As already discussed, modules such as text analytics module 235, anomalous events module 243, and social network analysis module 237 may comprise separate and independent hardware elements or, in some embodiments, share hardware. They may likewise have separate software implementations which can communicate with one another or have integral software implementations.

Both captured and processed data are preferably stored on non-volatile memory storage media in data warehouse 733, as is transactional data generated in the course of business. Security software and/or hardware may be used to limit and control access and use of the system 713. Managers, employees, and any other qualified personnel may access system 713 and run the methods and processes taught herein via output/input devices 701. While FIG. 7 shows just one exemplary network configuration, other hardware and network configurations will be apparent to those of skill in the art in the practice of the invention.

During any stage of analyzing, in particular at any transition between modules as indicated by arrows in FIG. 2, data may temporarily or permanently stored in one or more data warehouses 733 (shown in FIG. 7). Preferably all results which may be supplied in execution 280 are stored on non-volatile storage media in a data warehouse 733.

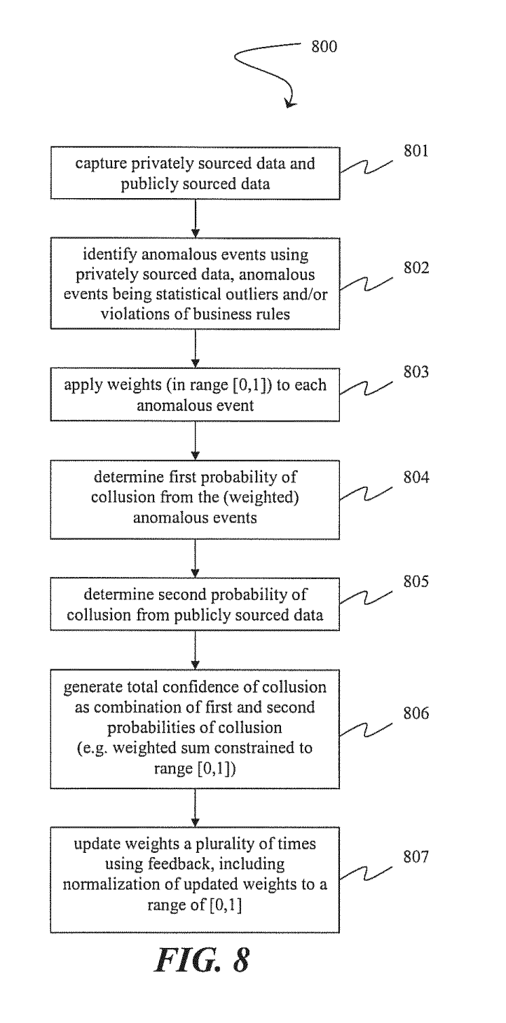

FIG. 8 shows a method 800 which combines that which is taught in FIGS. 4 and 5, providing a comprehensive solution for identifying fraudulent or risky entities in procurement. At step 801, privately sourced data and publicly sourced data are captured, generally with a server in communication with one or more data input devices. Anomalous events are identified (e.g. with a processor) using the privately sourced data (step 802). The anomalous events are generally selected from the group consisting of statistical outliers and violations of one or more of a plurality of business rules by an entity. Weights are applied to each of the anomalous events, the weights being in a range of [0,1] (step 803). A first probability of collusion (cᵣ) is determined from the anomalous events (and thus from the privately sourced data) for the entity and at least one other entity (step 804). A second probability of collusion (p_{c}) is determined from the publicly sourced data for the entity and the at least one other entity (step 805). A total confidence of collusion (cₜₒₜ) is generated (e.g. at an output device) by combination of the first probability of collusion and the second probability of collusion (step 806). This combination is a weighted sum of the first probability of collusion and said second probability of collusion constrained to a range of [0,1]. It can be advantageous to provide a further step 807 of updating one or more of the weights as a function of user feedback identifying the anomalous events as indicative of fraud, not indicative of fraud, or else indicative of interest, with the updating being performed multiple times and including normalization of updated weights to a range of [0,1].

Although embodiments herein are largely drawn to publicly sourced data in the form of social media data and privately sourced data in the form of transactional data, other types of publicly sourced data and privately sourced data may also be used in the practice in the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While preferred embodiments of the present invention have been disclosed herein, one skilled in the art will recognize that various changes and modifications may be made without departing from the scope of the invention as defined by the following claims.

Having thus described our invention, what we claim as new and desire to secure by Letters Patent is as follows:

1. A computer-implemented method for identifying fraudulent or risky entities in procurement, comprising the steps of:
capturing both privately sourced data and publicly sourced data with a server in communication with one or more data input devices;
identifying anomalous events with a processor using said privately sourced data, said anomalous events being selected from the group consisting of statistical outliers and violations of one or more of a plurality of business rules by an entity;
applying weights to each of said anomalous events, said weights being in a range of [0,1];
generating at an output device a total confidence of collusion by combination of a first probability of collusion and a second probability of collusion, wherein
said first probability of collusion is determined from said anomalous events for said entity and at least one other entity,
said second probability of collusion is determined from said publicly sourced data for said entity and said at least one other entity, and
said combination is a weighted sum of said first probability of collusion and said second probability of collusion constrained to a range of [0,1].

2. The computer-implemented method of claim 1, further comprising the step of updating one or more of said weights as a function of user feedback identifying said anomalous events as indicative of fraud, not indicative of fraud, or else indicative of interest, wherein said updating step is performed a plurality of times and includes normalization of updated weights to a range of [0,1].

3. The computer-implemented method of claim 1, wherein said entity is a vendor and said at least one other entity is one or more employees of a customer of said vendor.

4. The computer-implemented method of claim 1, wherein said privately sourced data includes transactional data and said publicly sourced data includes social media data.

5. The computer-implemented method of claim 1, further comprising the step of analyzing said privately sourced data with a processor using a text analytics module.

6. A computer program product for sequential probabilistic learning, said computer program product comprising a computer readable storage medium having program instructions embodied therewith, said program instructions executable by a processor to cause said processor to perform the steps comprising of:
receiving from one or more input devices weights for one or more anomalous events, said one or more anomalous events being selected from the group consisting of statistical outliers and violations of one or more of a plurality of business rules by an entity and having each an associated unitary confidence of fraud between said entity and at least one other entity; and
updating one or more of said weights as a function of user feedback identifying said anomalous events as indicative of fraud, not indicative of fraud, or else indicative of interest, wherein said updating includes normalization of updated weights to the range [0,1].

7. The computer program product of claim 6, wherein said entity is a vendor and said at least one other entity is one or more employees of a customer of said vendor.

8. The computer program product of claim 6, wherein said updating step is performed a plurality of times.

9. A computer program product for generating a total confidence of collusion between an entity and at least one other entity, said computer program product comprising a computer readable storage medium having program instructions embodied therewith, said program instructions executable by a processor to perform the steps comprising of:
receiving at an input device a first probability of collusion determined from privately sourced data for said entity and said at least one other entity;
calculating a second probability of collusion from publicly sourced data for said entity and said at least one other entity, said calculating including
determining an edge probability and edge weight according to a relationship type between said entity and said at least one other entity,
finding a shortest path between said entity and said at least one other entity; and
combining said first probability of collusion and said second probability of collusion as a weighted sum constrained to a range of [0,1].

10. The computer program product of claim 9, wherein said entity is a vendor and said at least one other entity is one or more employees of a customer of said vendors.

11. The computer program product of claim 9, wherein said privately sourced data includes transactional data and said publicly sourced data includes social media data.

12. The computer program product of claim 9, wherein said publicly sourced data includes social media data and said relationship type and said shortest path are determined from social media data associated with said entity and said at least one other entity.

13. The computer program product of claim 9, wherein said privately sourced data includes transactional data showing anomalous events selected from the group consisting of statistical outliers and violations of one or more of a plurality of business rules by said entity.

14. A computer-based network system for identifying fraudulent or risky entities in procurement, comprising:
input devices configured to receive and transmit either or both privately sourced data and publicly sourced data;
one or more servers configured to capture said privately sourced data and publicly sourced data from said input devices;
one or more computers in communication with said one or more servers, said one or more computers being configured to perform the steps comprising of:
identifying anomalous events using said privately sourced data, said anomalous events being selected from the group consisting of statistical outliers and violations of one or more of a plurality of business rules by an entity;
applying weights to each of said anomalous events, said weights being in a range of [0,1];
generating a total confidence of collusion by combination of a first probability of collusion and a second probability of collusion, wherein
said first probability of collusion is determined from said anomalous events for said entity and at least one other entity,
said second probability of collusion is determined from said publicly sourced data for said entity and said at least one other entity, and
said combination is a weighted sum of said first probability of collusion and said second probability of collusion constrained to a range of [0,1]; and
one or more output devices configured to receive said total confidence of collusion generated from said one or more computers.

15. The computer-based network system of claim 14, wherein said one or more computers are further configured to perform the step of updating one or more of said weights as a function of user feedback identifying said anomalous events as indicative of fraud, not indicative of fraud, or else indicative of interest, wherein said updating step is performed a plurality of times and includes normalization of updated weights to a range of [0,1].

16. The computer-based network system of claim 14, wherein said entity is a vendor and said at least one other entity is one or more employees of a customer of said vendor.

17. The computer-based network system of claim 14, wherein said privately sourced data includes transactional data and said publicly sourced data includes social media data.

18. The computer-based network system of claim 14, wherein said one or more computers are further configured to perform the step of analyzing said privately sourced data with a text analytics module.

19. The computer-based network system of claim 14, wherein said publicly sourced data includes social media data, and wherein at least one of said input devices is a server of a social media network provider configured to receive social media data from end user devices and serve said social media data to said one or more servers.
